(19) United States
(12) Patent Application Publication
(10) Pub. No.: US 2005/0217349 A1
(43) Pub. Date: Oct. 6, 2005

(54) System and method for simulating lubricating oil testing

(75) Inventors: Eric Stremler, Paris (FR); Patrick Naim, Saint Quen (FR)

Correspondence Address: CHEVRON TEXACO CORPORATION, P.O. BOX 6006, SAN RAMON, CA, 94583-0806, US

(73) Assignee: Chevron Oronite S.A.

(21) Appl. No.: 10/814,005

(22) Filed: Mar. 30, 2004

(51) Int. Cl. G01N 17/00

(52) U.S. Cl. 73/53.05; 73/865.6

(57) ABSTRACT

A method of simulating and optimizing qualification testing of lubricating oil products, the method including: passing a plurality of lubricating oil product characteristics to a simulator engine, where the simulator engine includes a plurality of simulated qualification tests and processing the lubricating oil product characteristics in one or more of the simulated qualification tests, where the output of each simulated qualification test includes a probability of passing indicator for indicating the probability that a lubricating oil product have the inputted characteristics would pass an actual qualification test; passing an input of the plurality of lubricating oil product characteristics, the probability of passing indicator from each simulated qualification test, and a proposed test sequence of a plurality of qualification tests to a strategy simulator engine and processing the input to determine a probability of passing indicator, cost and time duration of the proposed test sequence.

### COPYRIGHT NOTICE AND AUTHORIZATION

This patent document contains material which is subject to copyright protection.

© Copyright 2004. Chevron Oronite S.A. All rights reserved.

With respect to this material which is subject to copyright protection. The owner, Chevron Oronite S.A., has no objection to the facsimile reproduction by any one of the patent disclosure, as it appears in the Patent and Trademark Office patent files or records of any country, but otherwise reserves all rights whatsoever.

### I. FIELD OF THE INVENTION

The invention relates to computer-implemented process and system for simulating the results of actual lubricating oil tests.

### II. BACKGROUND OF THE INVENTION

Lubricating oils intended for use in internal combustion engines are a complex mixture of various components, including base oil, performance-enhancing additives, viscosity modifiers, and pour point depressant. Before a new lubricating oil blend can be sold, it must meet various industry-established performance/qualification tests. The results of the tests must be consistent with the labeling and marketing used when selling the new blend. The qualification tests include laboratory bench tests and internal-combustion engine tests.

Tests include tests for viscosity, seal compatibility, oil oxidation, piston deposit, cam or lifter wear, and ring sticking. Such tests require use of expensive laboratory and human resources. Example costs of such tests are $80,000 for the Daimler Chrysler OM441LA or Mack T-10 engine tests and $35,000 for the Daimler Chrysler OM602A engine test.

With available methodologies, product qualification engineers are only able to prepare test plans using spreadsheet tools like Excel in a very simple way. Test plans are not systematically available because of a lack of tool for preparing them. Only very few test models are available for pass/fail prediction because data preprocessing is not available in an automated system. The concept of simulating several test models together has not been implemented. Code of practice issues can only be checked when faced with actual problems without much anticipation. The level of input data and information to be used by the product qualification engineer is overwhelming when preparing an efficient test plan. With known methods and tools, it is impossible for an engineer to take all of this data and information into account in a rational way. This has become even more true in the past 5 years due to the ever increasing complexity of the lube oil qualification environment. No known solutions exist that makes use of a rule engine for code of practice guidelines management or that simulates and optimizes complete lube oil test programs.

It would be desirable to have a computer-implemented simulator which could include models of the qualification tests. Such a simulator would predict the likely outcome if the lube blend in question were submitted to the actual qualification tests. By using such a simulator, the time and cost of developing new blends could be reduced. The invention provides such a simulator.

### III. SUMMARY OF THE INVENTION

The invention includes a method of simulating and optimizing qualification testing of lubricating oil products, the method including: passing a plurality of lubricating oil product characteristics to a simulator engine, where the simulator engine includes a plurality of simulated qualification tests and processing the lubricating oil product characteristics in one or more of the simulated qualification tests, where the output of each simulated qualification test includes a probability of passing indicator for indicating the probability that a lubricating oil product have the inputted characteristics would pass an actual qualification test; passing an input of the plurality of lubricating oil product characteristics, the probability of passing indicator from each simulated qualification test, and a proposed test sequence of a plurality of qualification tests to a strategy simulator engine and processing the input to determine a probability of passing indicator, cost and time duration of the proposed test sequence.

Another embodiment of the invention includes a system for simulating and optimizing qualification testing of lubricating oil products, the system including: a CPU; a memory operatively connected to the CPU, the memory containing a program adapted to be executed by the CPU and the CPU and memory cooperatively adapted for simulating qualification testing of lubricating oil products; a simulator engine code segment embodied on a computer-readable medium configured and adapted for receiving as input a plurality of lubricating oil product characteristics, where the simulator engine includes a plurality of simulated qualification test code segments, and configured and adapted for processing the input of lubricating oil product characteristics in one or more of the simulated qualification test code segments, where the output of each simulated qualification test code segments includes a probability of passing indicator for indicating the probability that a lubricating oil product have the inputted characteristics would pass an actual qualification test; a strategy simulator code segment embodied on a computer-readable medium configured and adapted for receiving as a second input the plurality of lubricating oil product characteristics, the probability of passing indicator from each simulated qualification test code segment, the plurality of lubricating oil product characteristics, and a proposed test sequence of a plurality of qualification tests, and processing the second input to determine a probability of passing indicator, cost and time duration of the proposed test sequence.

These and other features and advantages of the present invention will be made more apparent through a consideration of the following detailed description of a preferred embodiment of the invention. In the course of this description, frequent reference will be made to the attached drawings.

### IV. BRIEF DESCRIPTION OF THE DRAWINGS

FIG. 1 depicts in one embodiment a schematic system diagram for the invention.

FIG. 2 depicts in one embodiment a table for use in the Rules Engine aspect of the invention.

FIG. 3 depicts in one embodiment a schematic layer-view system diagram for one illustrative implementation of the invention.

FIG. 4 depicts in one embodiment a more detailed schematic system diagram of the Data Management component for one illustrative implementation of the invention.

FIG. 5 depicts in one embodiment a more detailed schematic system diagram of the user interface component for one illustrative implementation of the invention.

FIG. 6 depicts in one embodiment a schematic process flow diagram with a logical view of the data for one illustrative implementation of the invention.

FIGS. 7 and 8 depict in two different embodiments schematic diagrams of the variations of tested complete lubricant composition used as part of a test strategy.

FIGS. 9-17 depict in one embodiment a schematic process logic flow diagram for use in the strategy simulator aspect of the invention.

FIGS. 18-28 depict in one embodiment a graphical user interface for some aspects of the system of the invention.

### V. DETAILED DESCRIPTION OF THE DRAWINGS AND PREFERRED EMBODIMENTS

A. Introduction

The following discussion and figures include a general description of a suitable computing environment in which the invention may be implemented. While the invention may be described in the general context of a system and an application program that runs on an operating system in conjunction with general purpose computers, an internet, and web application, and email servers and clients, those skilled in the art will recognize that the invention also may be implemented in combination with other program modules. Generally, program modules include routines, programs, components, data structures, etc. that performs particular tasks or implement particular abstract data types.

Moreover, those skilled in the art will appreciate that the invention may be practiced with other computer system configurations, including hand-held devices, multiprocessor systems, microprocessor-based or programmable consumer electronics, minicomputers/servers, workstations, mainframe computers, and the like.

The invention may also be practiced in distributed computing environments where tasks are performed by remote processing devices that are linked through a communications network. In a distributed computing environment, program modules may be located in both local and remote memory storage devices.

Then invention generally relates to a simulation system for qualifying lubricating oils. The process aspects of the invention are a series of process steps utilizing, in whole or in part, the system herein and variations thereof. As would be clear to one skilled in the art, the process steps can be embodied in part as code for a computer program for operation on a conventional programmed digital computer, such as a client and server. The program code can be embodied as a computer program on a computer-readable storage medium or as a computer data signal in a carrier wave transmitted over a network.

B. Illustrative Benefits of the Invention

The System helps solve the following problems which relate to qualifying lube oils: automatic data conditioning, automatic test modeling, systematic checking of code of practice rules, automatic strategy simulator for risk analysis with probability of success of a potential test program along with average cost and duration, automatic strategy optimization for best trade off between program cost, duration, probability of pass and product cost. The System allows complete program simulations for better decision making and risk assessment.

C. Illustrative Implementation Environment

An illustrative implementation environment includes: a Java virtual machine, (e.g., JDK 1.3) to support all Java software components. All System components are optionally written in full Java, except for external libraries. A web server (e.g., Apache) to interpret the http code generated by the JSP pages within the System pseudo-component GUI. A servlet engine (e.g., Resin or Tomcat) to execute the Java Server Pages of the System pseudo-component GUI. A database (e.g., ORACLE) that handles all persistent data used within the System.

Actual access to DATA within the System is taken care of by a unique component (DAT), and this access is performed using the JDBC API. Third parties software components or libraries such as STORM™ (from software vendor Elseware) for neural networks and HUGIN™ (from software vendor HUGIN) for Bayesian networks and Blaze Advisor™ (from software vendor Fair Isaac) as code of practice rule engine. An external Extract/Transform/Load (“ETL”) procedure, built, e.g., with Informatica brand software, is in charge of filling the System database with data extracted and transformed from past physical qualification tests databases and other sources. The ETL tool is used to extract data from one or more source DB, transform the data and load it on a target DB.

D. Algorithms

Suitable algorithms include Bayesian and Neural Networks, Monte Carlo simulator, Non Dominated Sorting Genetic Algorithm, and mixed RETE/Prolog like Algorithm for the rule engine. Details on each can be found in the publications in the field.

E. Overview of System Architecture

The functional architecture of the System is summarized in the picture below. the System is comprised of five main functional components: Data Representation (also called Data Collapsing), Model Building, Model Execution, Compliance Evaluation, and Simulation. These components do not necessarily correspond to a software module depending on how the System is implemented. For instance, the data collapsing function may optionally be used in several software modules in the System. This decomposition is the most appropriate to understand how the System works, without going into potential implementation details.

F. The User Point of View

In order to benefit from the System risk analysis derived from the Monte Carlo simulation of a test program, the PQ engineer has to feed some information into the System. Typically, for a standard program, 1 or 2 hours of preliminary work are required to enter the variants and the strategies definition. By “variants” we mean here the set of finished oils that may be used during a program. This may require a slight change of work habits for the PQ engineers. Indeed, it will be necessary to consider all potential options in terms of formulation before starting a program, or at least to be as exhaustive as possible. The same effort is needed for the test plan. A strategy is typically an ordered sequence of tests that would have to be passed for the program to be successful. But defining a strategy requires also to consider alternatives (e.g., what if this test fails more than 3 times.) This new way of working may seem more like a constraint, but considering the alternatives is the basis of any rational risk analysis process.

G. Data Representation

In order to simulate a program test, the System needs creating input/output models in the form “Finished Oil|Performance”. A finished oil is typically defined by a list of 10 to 20 constituents: additives, viscosity improver, pour point depressant, and base stocks. A test result is defined by one or more measurements performed after using the finished oil. For instance, in an engine test, some wear measurements will be performed after operating the engine for 2-300 hours. If one tries to organize all the data available for one particular test into a table, one would typically have one column per constituent, and one line per test run. But the potential number of constituents is very large (i.e., more than the number of base stocks). This means that the table would be very sparse. No statistical modeling technique can infer anything from such data.

However, it's known that the name of one particular constituent is not important, its properties are. We know that the group or the total polar dosage of a base oil may have some impact, whatever the manufacturer of the oil. That was one of the major tasks in the System: reach an agreement among experts to define a data representation independent of constituent names, but rather based on generic descriptors. We call this representation a “data collapsing”. The data collapsing can be implemented via various known methodologies. This representation may evolve. The System has been designed to be independent of the data collapsing used.

H. Model Building

All the System models are input/output models in the form “Finished Oil|Performance”. One of the benefits of the System is that test models merge two sources of knowledge: expert knowledge and empirical knowledge. Formulators are the experts that provide the qualitative knowledge for the System models. During the System development phase, more than 120 interviews of formulators have been conducted, to gather their beliefs on the main factors driving the test results. Typical number of samples for an engine test of interest (i.e. an engine test which is not obsolete) is 100-200. And even though the data representation for a given formulation has been made compact (as discussed above), adjusting a model with potentially 90 input variables on 100 samples is very likely to yield to over fitted models. This is why formulators' expertise is fundamental to keep model building focused and to obtain robust models. Most System models for engine tests will be built using this type of hybrid knowledge. For some models, typically bench tests, when a significant number of test runs are available, we consider the use of purely data-driven procedures.

I. User Inputs and Model Execution

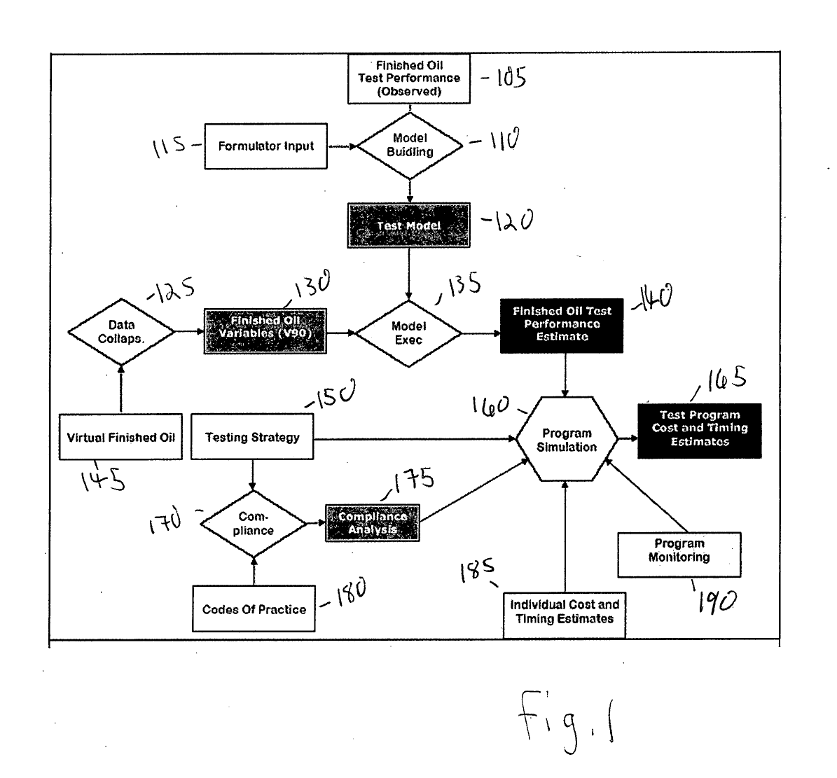

FIG. 1 shows the general architecture of the System. For a detailed discussion of FIG. 1 see the discussion of Figures section below. The PQ engineer input, typically the finished oil he/she plans to use, and the test plan he/she has in mind. Preferably, the PQ engineer updates the test plan monitoring information in the System. Other sources of inputs are shown in FIG. 1, e.g., lube oil composition formulator expertise on variable selection.

The System intermediate results include test models, finished oil in V90. Output is Finished oil test performance and test program cost and timing probabilities.

The System modules are shown in FIG. 1. Model execution is the core of the System simulator. During a simulation, the finished oils that have been assigned to a program by the PQ engineer will actually go through virtual tests. For a finished oil, going through a virtual test precisely means: The formulation of the finished oil is transformed into a vector of variables x, according to the data collapsing used. This vector is then input to the test model, which computes an output y=f(x). This output is usually a vector since a test usually has more than one outcome being monitored. This output is not the final outcome of the virtual test.

Since we want to reproduce the partially random behavior of a test, the final outcome is sampled according to a random distribution. The mean of the distribution is the output of the test model, and its variance is the residual variance of the test model. In other words, this means that if the model shows poor explanatory power (high residual variance), the final outcome of the virtual test will be almost purely random. On the other hand, if the test model is accurate, final outcome of the virtual test will be almost deterministic. The form of the distribution used for sampling will depend on the quality of the empirical distribution observed. Usually, this will be either normal or lognormal distribution.

J. Compliance Evaluation

Compliance evaluation relates to the strategy aspect of the System. For a PQ engineer, designing a virtual test program also involves considering when he/she will implement a minor formulation modification. For instance: Start the test plan with formulation OR-F1. If the XUD11 sequence clearly fails more than 3 times, switch to a boosted formulation OR-F2. In complex simulations, it may become necessary to implement successive formulation modifications. In such cases, the formulations used at various stages of the program may be incompatible with respect to the codes of practice, such as ATC, or ATIEL.

A specific module in the System is in charge to analyze all strategies in order to identify formulations changes that would be in violation of the codes of practice. For the PQ engineer use, this module first produces a report showing all potential conflicts. This is particularly useful to identify mistakes in the formulations definition. But the main use of this module is to control the changes of formulation during the simulation.

When a change of formulation is implemented during a simulation, the System compliance module will make sure that all tests that have been considered “Pass” in the previous steps of the simulation would still hold with the new formulation. The System compliance module is also used for suggesting VGRA, and for checking the conformity of base oil interchanges.

K. Program Simulation

Program simulation (also referenced as “Monte Carlo simulator”) is a core component of the System. The Monte Carlo simulator virtually runs several thousands times the test plan strategy that was defined by the PQ engineer. For each run, all the instructions specified in the strategy are respected: order of tests, tests run in parallel, formulation changes, and other aspects. A single run of the test plan can yield to two situations: The test plan is successful: this means that all tests were finally “pass” (this may have required several repeats, formulation changes, etc.) or the test plan fails: this can happen only when one limitation has been set (either to the number of repeats allowed, the test plan budget, or the test plan timing).

Based on several thousands of runs, the System can compute various statistics: e.g., Pass rate, Average cost and timing, Distribution of cost and timing, and Most probable successful variant. It is important to understand the statistical nature of this inference, which we describe here as a causal graph.

The program final result is essentially random. Its distribution can only be shifted in more favorable regions. A successful strategy involves the formulators' input of a formulation designed with a sufficient probability of success and the PQ engineers' input of a test strategy which can reduce the cost or timing on average.

L. Detailed Description of the Figures

The invention and exemplary implementations thereof will now be described with reference to the figures. FIG. 1 depicts in one embodiment a schematic system diagram for the invention. Inputs from product engineers, who are intended users/operators of the system, include the proposed finished oil 145, the test plan 150, and optionally updates to the test plan obtained by monitoring of actual test results 190. Additional inputs include formulator expertise on variable selection for models 115, data from a database of physical tests 105, and codes of practice 180. Intermediate results of the system include test models 120, finished oil in V90 format 130 (i.e. 90 variables in a collapsed format), and strategy compliance analysis 175.

Final output of the system includes Finished Oil Test Performance Estimate 140 and Test Program Cost and Timing Estimates 165. System modules are Test Model(s) 120 (set of individual test simulators) and Program Simulation module 160 (a strategy simulator). The system modules are described in more detail in this below.

The Program Simulation module 160 takes as input data describing an actual or potential (i.e., virtual) new lube blend. The input data includes as many as 90 parameters such as dispersant level, antiwear level, additive package treat rate, base stock level, VI improver level, Pour Point Depressant, base oil blend viscosity, kinematic viscosity, HTHS viscosity, sulfated ash etc . . . . This data is passed to the Program Simulation module 160, passed through one or more qualification Test Models 120 within the Program Simulation module 160, and the output includes the probability that the lube blend will pass one or more qualification tests of interest, i.e., Test Program Cost and Timing Estimates 165.

The qualification Test Models 120, the key ones being the Engine and Bench test models, are constructed in software using advanced statistical methods. In particular, they may be based on Bayesian and Neural Network modeling techniques. Other techniques may also be suitable. The Bayesian and/or Neural Network and/or other modeling techniques used in the invention may be developed internally or obtained in a software package licensed from an outside vendor. The models are constructed, in part, by inputting several years of actual qualification test data, preferably 15 years or more, into a Model Building engine 110, e.g., one using the previously mentioned Bayesian and/or Neural Network modeling techniques.

The Program Simulation module 160 takes as input data describing the test sequence planned as well as the minor formulation changes envisaged during the test plan execution, i.e., collectively making up Testing Strategy 150. Using Monte Carlo techniques, the Program Simulation module 160 produces output that may also include expected cost and duration necessary to perform the actual tests to a successful completion, i.e., Test Program Cost and Timing Estimates 165.

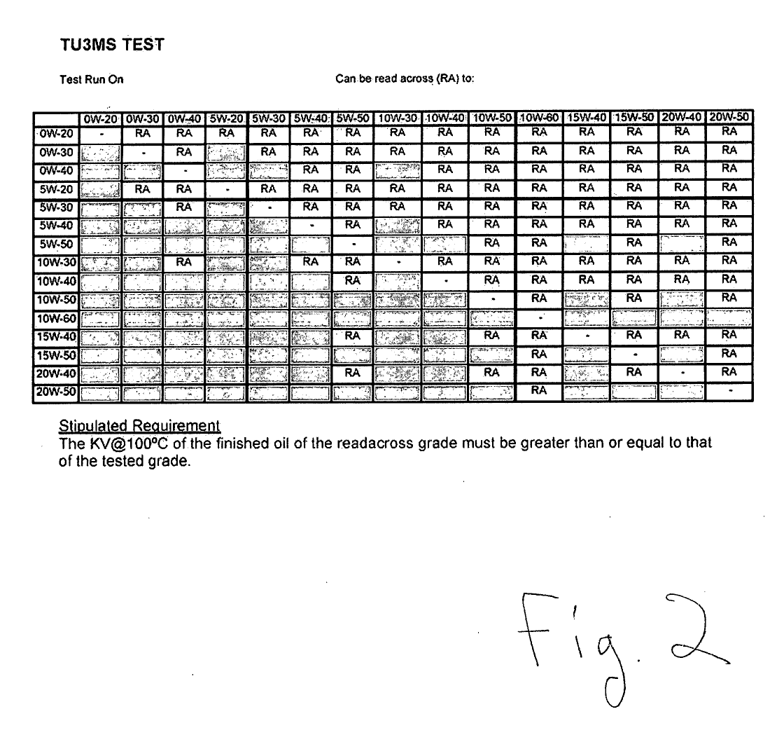

During the simulation, the Program Simulation module 160 is constantly checking that the Testing Strategy 150 executed will be compliant with the current “Codes of Practice” 180 for lubricant oil testing. To do so, the invention includes a “Rules Engine” (not shown) which may be internally developed or obtained from an outside vendor. A Rules Engine permits a user of the invention to establish desired Codes of Practice rules 180 using a user-friendly, plain-English interface. The Rules Engine then converts the plain-English rule into the desired computer-programming language, e.g., Java. Example rules a user may wish to create include, e.g.:
Rule 1: (ATC; h.1) No decrease in treatment level of either the entire performance additive package or its individual components is allowed, except within the context of permissible rebalances.
Rule 2: (ATC; h.3) One new component addition (separate from permissible rebalances) is allowed, subject to its final level being no more than 10% by mass of the final performance additive package.
Rule 3: The KV@100C of the finished oil of the read across grade must be greater than or equal to that of the tested grade. See FIG. 2.

Another aspect of the invention is it can establish compliance with “Code of Practice” agreements. Code of Practice agreements are signed by lubricant manufactures or lubricant component manufacturers on a yearly basis. The invention allows proof of compliance by systematically checking all the related Code of Practice rules applying to a simulated program in terms of formulation minor modifications, viscosity grade read across and base oil interchange guidelines.

Other required and/or optional components of the invention include a strategy optimizer (not shown), which explores the space of feasible strategies with techniques such as genetic algorithms, or simulated annealing. The optimizer proposes a candidate strategy based on test plan requirements and user objectives, such as cost or duration.

The invention may be built to operate on any conventional computer platform, but preferably is a web-based application accessible by any authorized user having a web browser connected to the Internet or company-internal Intra-net on which an application server containing the invention resides.

The invention may be constructed using conventional software engineering methods. Potential users of the invention will be Product Qualification personnel. New lube blend developers may also be users. Utilizing the system of the invention, from within one piece of software, the complete product qualification process can be both simulated and optimized.

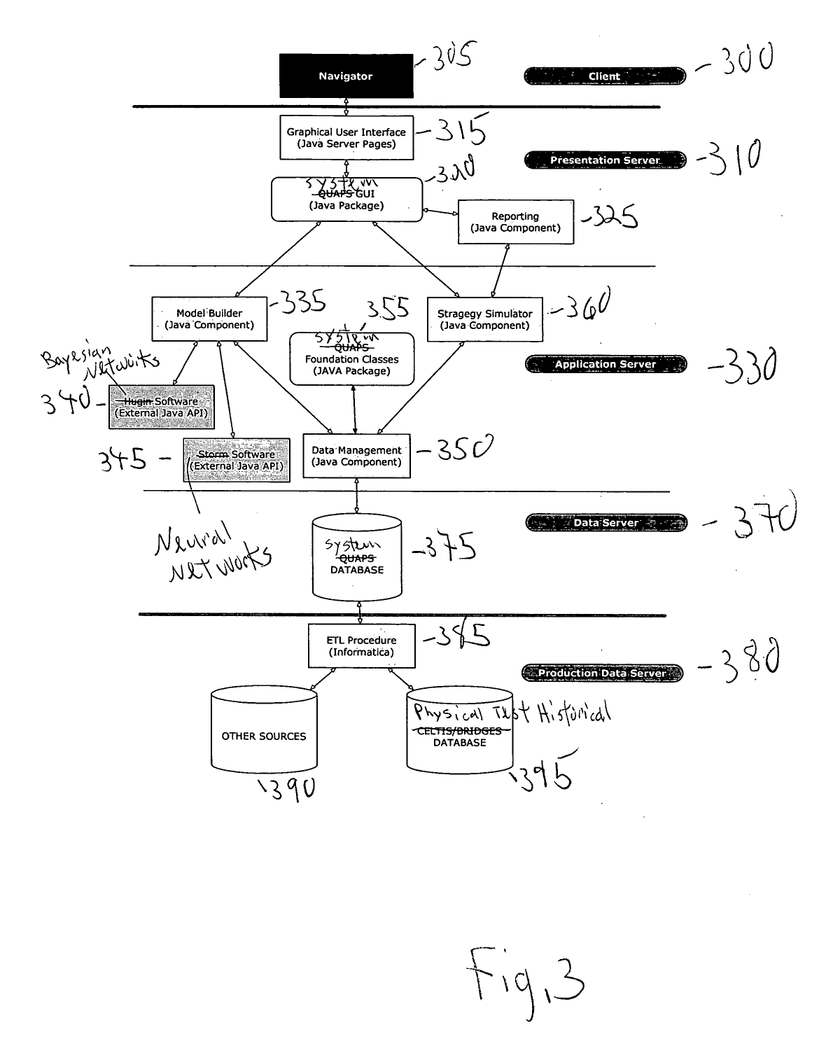

FIG. 3 depicts in one embodiment a schematic layer-view system diagram for one illustrative implementation of the invention. The layers are Client layer 300, Presentation Server layer 310, Application Server layer 330, Data Server layer 370, and Production Data Server layer 380. Client layer 300 includes Navigator 305 comprising a user interface, preferably a graphical user interface (“GUI”), optionally a web browser. Presentation Server layer 310 includes GUI (optionally Java Server Pages) 315 operatively connected to Navigator 305, GUI (optionally powered Java Server Pages) 315, operatively connected to System QUI (optionally a Java Package) 320, operatively connected to Reporting (optionally a Java component) 325.

Application Server layer 330 includes Model Builder (optionally a Java Component) 335 operatively connected to each of the following: Bayesian networks software (e.g., Hugin brand) (optionally an external Java API) 340, neural networks software (e.g., Storm brand) (optionally an external Java API), and Data Management (optionally a Java component) 350. Data Management 350 is operatively connected to both System Foundation Package (optionally a Java Package) 355, and Strategy Simulator (optionally a Java Component) 360. Strategy Simulator 360 is operatively connected to both System GUI 320 and Reporting 325.

Data Server layer 370 includes System Database 375 operatively connected to ETL Procedure 375 in Production Data Server layer 380. Production Data Server layer 380 also includes Other Sources database 390 and past physical lube oil tests database 395, each operatively connected to ETL Procedure 380.

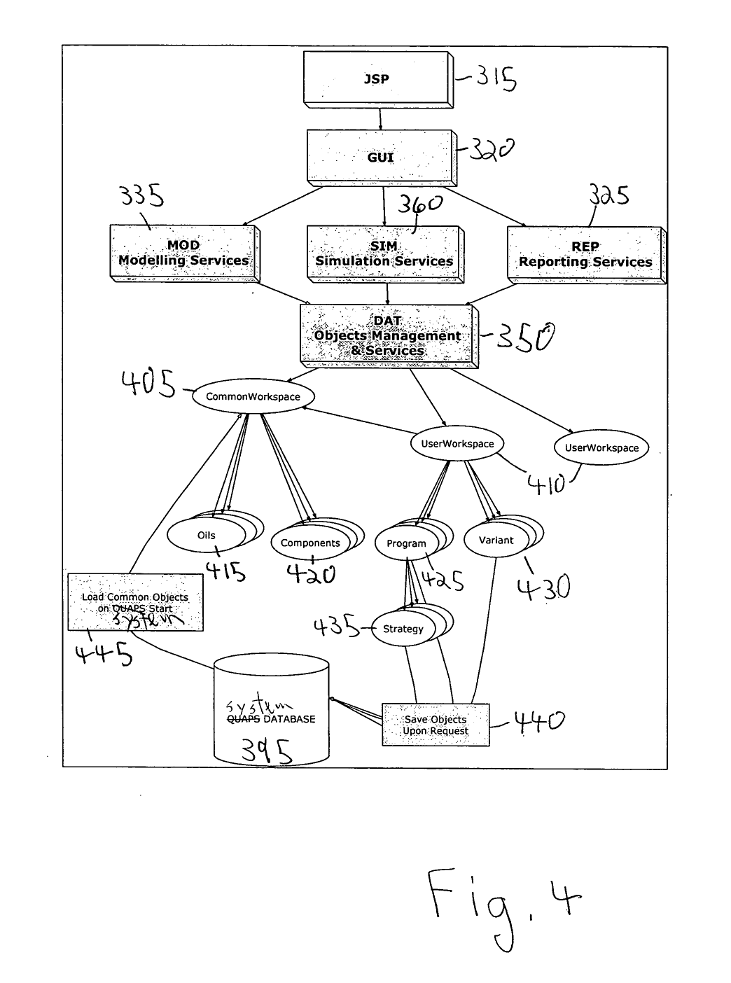

FIG. 4 depicts in one embodiment a more detailed schematic system diagram of the Data Management component for one illustrative implementation of the invention. Simplified views of the Presentation layer 310 (FIG. 3) and Application Server layer 330 (FIG. 3) are repeated in this FIG. 4 in JSP 315, GUI 320, Modeling Services 335, Simulation Services 360, Reporting Services 325, and data and Objects Management & Services 350. The emphasis in this figure is the more detailed view of the data and Objects Management & Services 350 (also called “Data Management module 350”). In one embodiment, the data managed in the Data Management module 350 is stored in a hierarchical/tree directory format, i.e., with a root directory, sub-directories, and sub-sub-directories.

The term directory as used here is by way of example only and is intended to indicate any available programming construct or other methodology for organizing data, files, or records. Higher levels of the directory include Common Workspace objects 405 and User Workspaces objects 410. Under each respective workspace are Oils objects 415, Components objects 420, Program objects 425, and Variant objects 430. Under Program objects 425, are Strategy objects 435. Load Common Objects on System Start module 445 and Save Objects Upon Request module 440 provide the functions indicated by the name of each module.

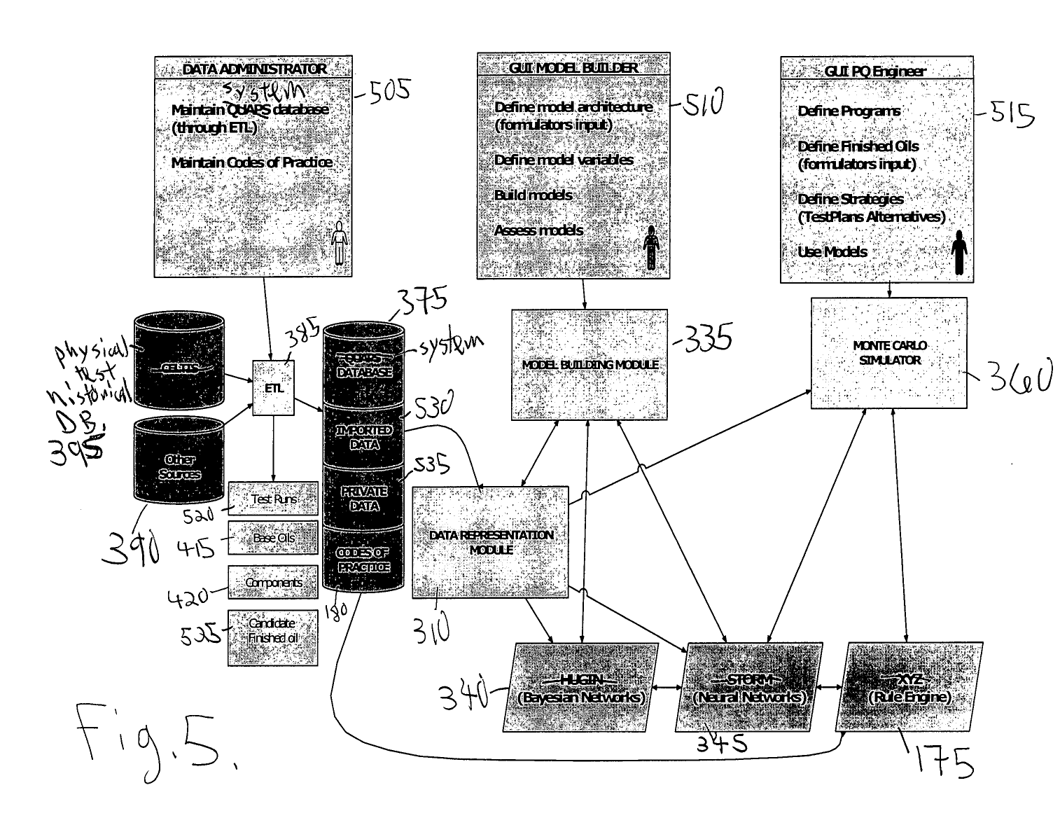

FIG. 5 depicts in one embodiment a more detailed schematic system diagram of the user interface component for one illustrative implementation of the invention. FIG. 5 repeats modules shown in FIG. 1, 3, or 4 and additionally shows point of interface between various users and the system. The roles of the different users are also listed. The roles of the Data administrator 505 include Maintain database and Maintain Codes of Practice. The Data administrator 505 interfaces with the system via ETL Procedure module 385.

The roles of the GUI Model Builder 510 include Define model architecture (formulators input), Define model variables, build models, and access models. The GUI Model Builder 510 interfaces with the system via Model Building module 335. The roles of the GUI Product Quality (“PQ”) Engineer 515 include Define Programs, Define Finished Oils (formulators input), Define Strategies (Test Plans and Alternatives), and Use Models. The GUI PQ Engineer 515 interfaces with the system via the Monte Carlo Simulator module (also called “Strategy Simulator”) 360.

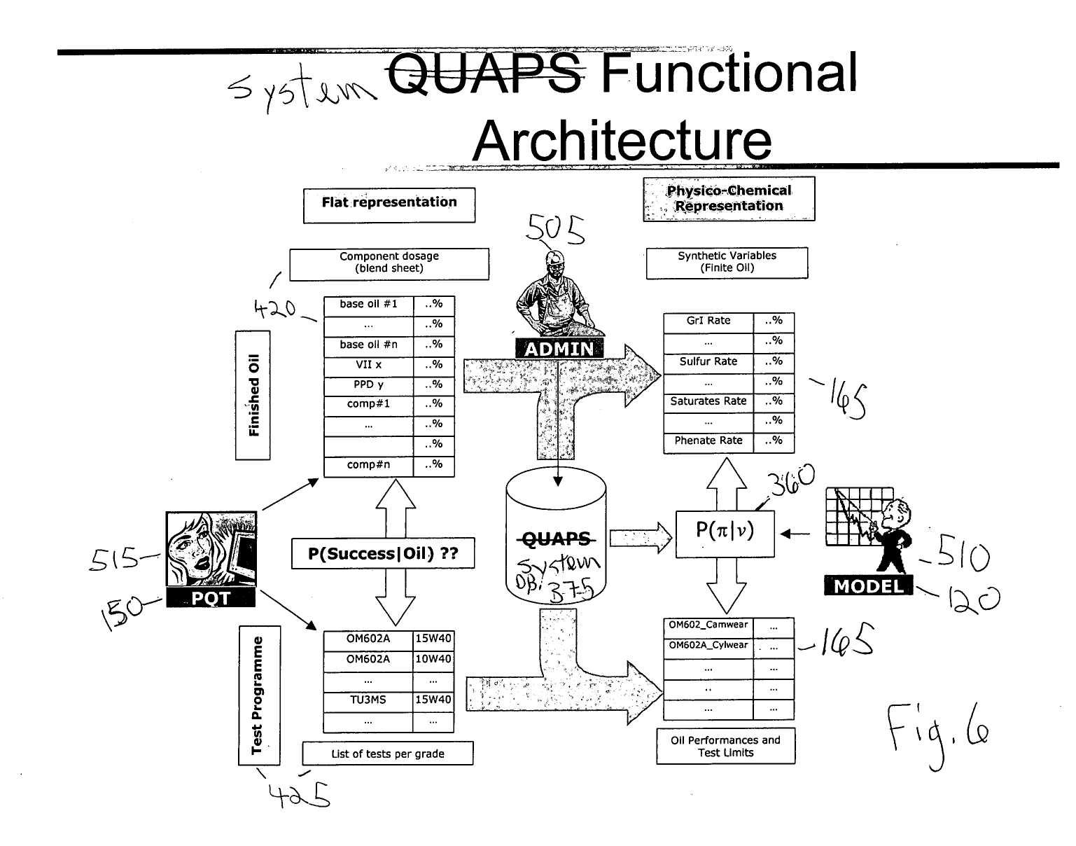

FIG. 6 depicts in one embodiment a schematic process flow diagram with a logical view of the data for one illustrative implementation of the invention. As in FIG. 5, this figure shows the users and their points of interface with the system. Product Quality engineer 515 inputs a test program 415 and oil 420 for entry into system database 375. These are passed to strategy simulator 360 along with model 120. The output is the probabilities of time, cost, and likelihood of passing the test program 165.

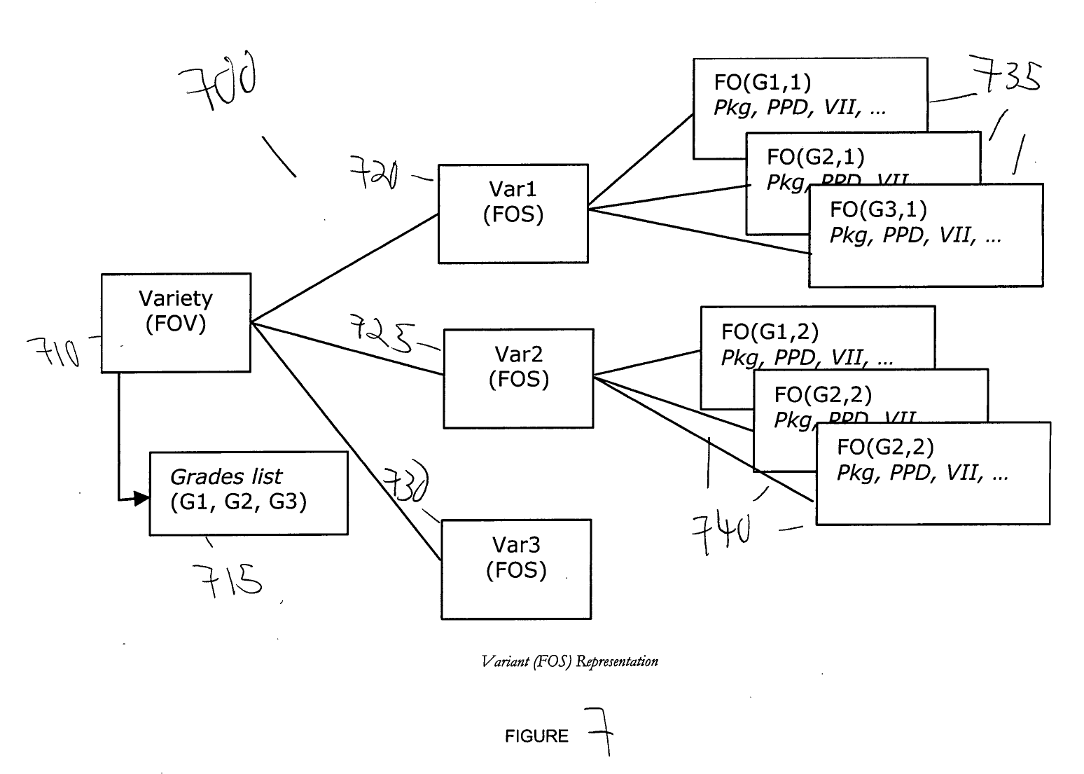

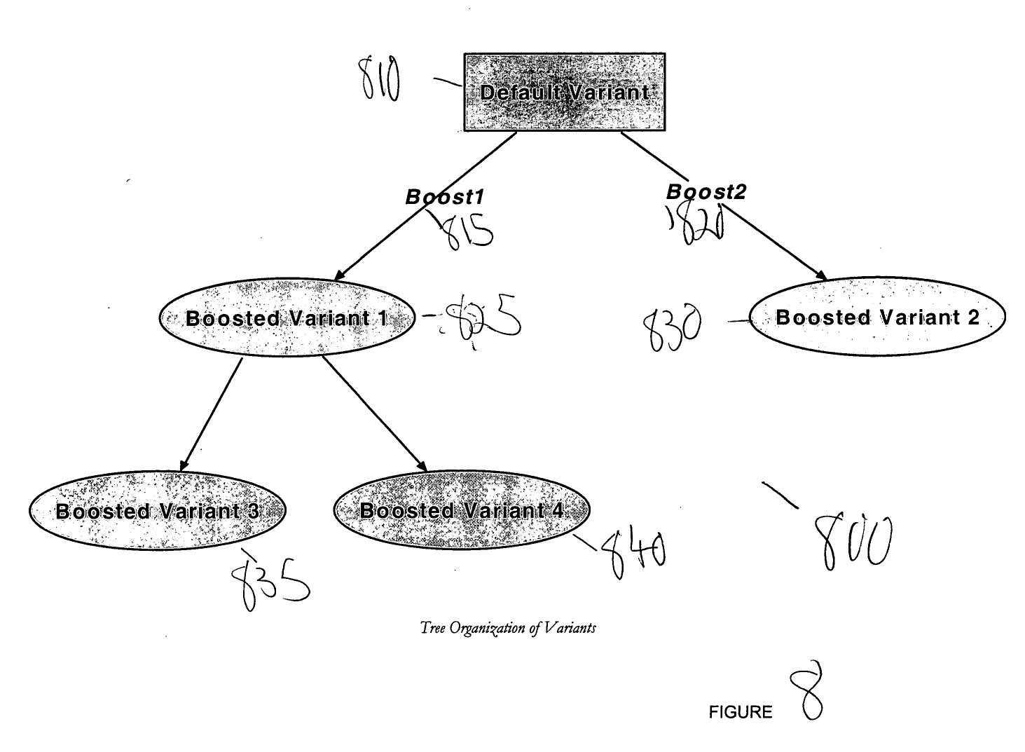

FIGS. 7 and 8 depict in two different embodiments schematic diagrams of the variations of tested complete lubricant composition used as part of a test strategy. FIGS. 7 and 8 each depict variations in a tree structure. In FIG. 7, node 710 represents a root node or the top node in a sub branch of a larger tree structure. Node 710 has child nodes 720, 725, and 730, and each of those nodes may have child nodes as with nodes 735 and 740. Each child node is a modification of the lube composition stored in its parent node. FIG. 8 depicts a similar tree structure. FIG. 8 additionally depicts what the change is between nodes. For example, the transition from Default Variant node 810 to Boosted Variant 1 node 825 is the addition of Boost1 815. The transition from Default Variant node 810 to Boosted Variant 2 node 830 is the addition of Boost2 820. Each boost may represent the addition or the increase of a component designed to overcome some deficiency in the lube composition as needed to pass a particular test in the test strategy.

Each tree structure of variants is preferably tested by Compliance Analysis module 175 (FIG. 1) to assure the tree complies with the Codes of Practice 180 (FIG. 1). These Code of Practice are lube industry, governmental, and/or OEM set rules which govern what mid-test program changes may be made in a lube composition without being required to repeat already successfully completed tests.

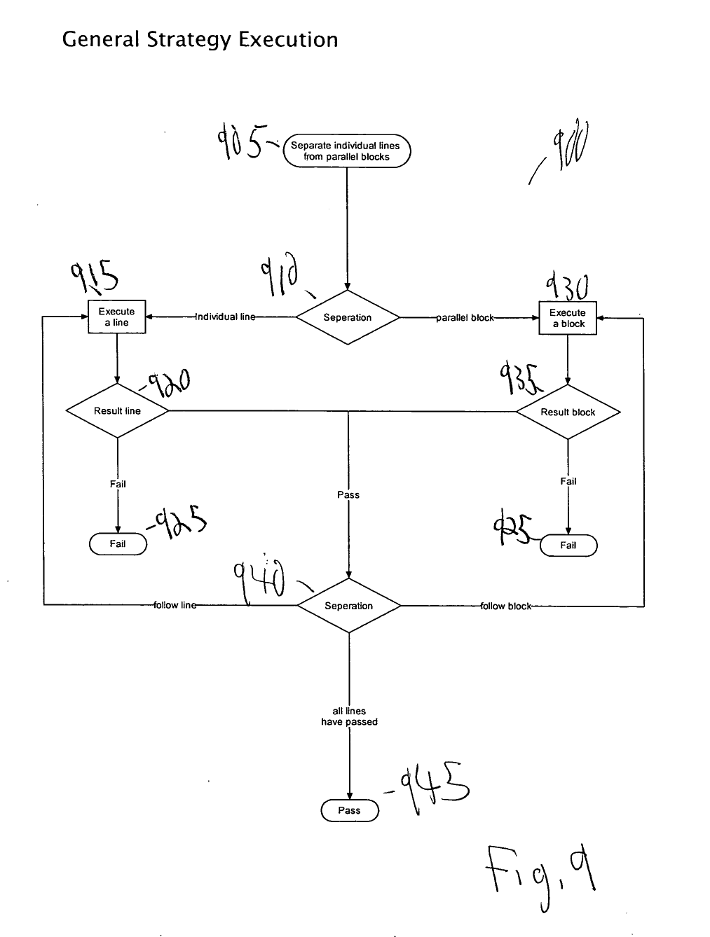

FIGS. 9-17 depict in one embodiment a schematic process logic flow diagram for use in the strategy simulator aspect of the invention. As discussed above a benefit of the system of the invention is automated changing of the lube variant used in the tests to better progress to a pass on all tests. As shown in the lube variant trees in FIGS. 7 and 8, there can be many variants as part of a test strategy. Tests or portions of test programs can be performed in parallel. Therefore, algorithms are necessary to address handling of the process flow during a test program. FIGS. 9-17 address this issue in various illustrative embodiments.

FIG. 9 depicts process logic flow for general strategy execution. Separate lines from parallel blocks 905 are separated 910 and executed by line 915 or by block 930. Where result line or block 920 and 935, respectively, either fails 925, if passes then another separation of line and block occurs 940 and the process is repeated until all lines have passed 945.

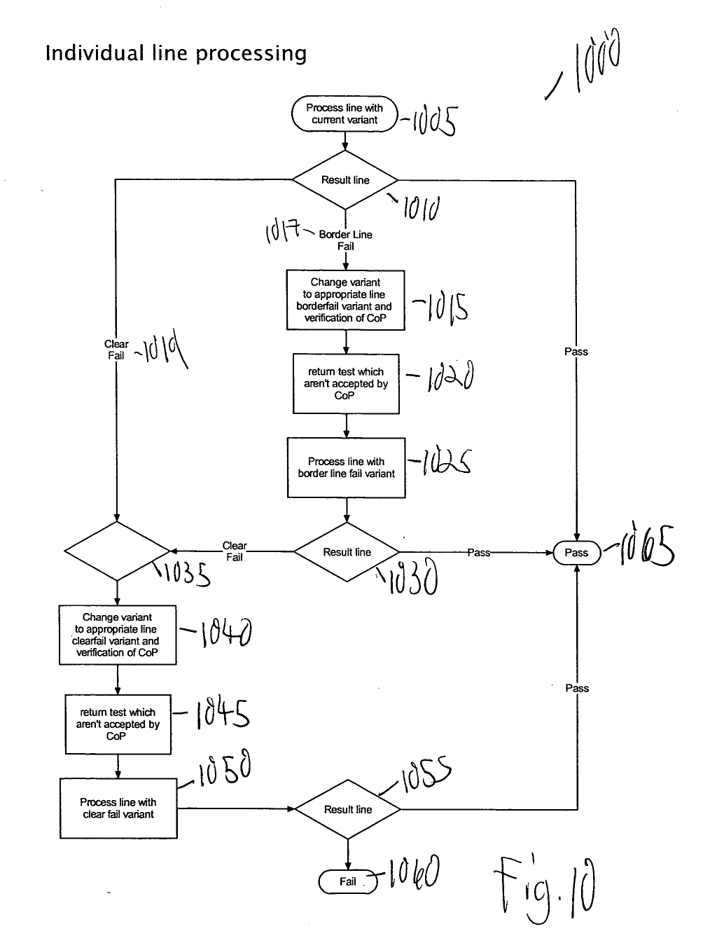

FIG. 10 depicts process logic flow for individual line processing. Start by processing the line with current variant 1005 and the result line 1010 either passes 1065, is a clear fail 1019, or border line fail 1017. Where a clear fail 1019, change the variant to appropriate line clearfail variant and verification of Codes of Practice (“CoP”) 1040, then return tests which are not accepted by CoP 1045, process line with the clear fail variant 1050, and determine in block 1055 if the result line passes 1065 or fails 1060.

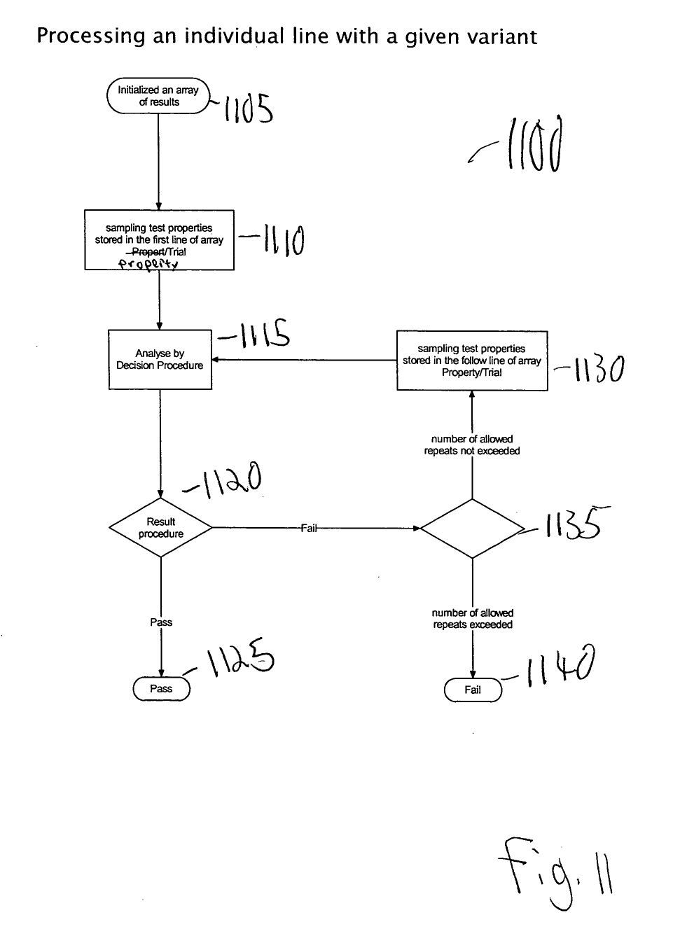

FIG. 11 depicts process logic flow for processing an individual line with a given variant. Begin by initializing an array of results 1105, then sampling test properties stored in the first line of array property/trial 1110, and then analyze by decision procedure 1115. Then the result procedure 1120 determines pass 1125 or fail 1135. If fail, then if number of repeats not yet exceeded then sampling test properties stored in the follow line of array property/trial 1130, then return to analyze by decision procedure 1115 and repeat as before until either pass 1125 or exceed number of allowed repeats 1140.

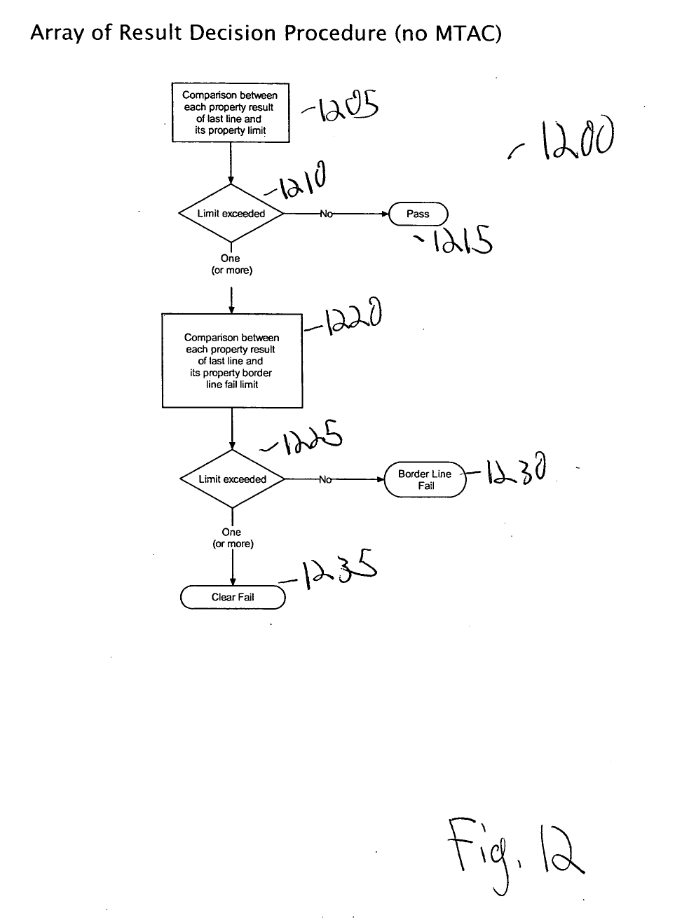

FIG. 12 depicts process logic flow for Array of Result Decision Procedure with no—Multiple Test Acceptance Criteria (“MTAC”). Begin with comparison between each property result of last line and its property limit 1205, if limit not exceeded then pass 1215, else then comparison between each property result of last line and all it's property border line fail limit 1120. If limit exceeded 1225, then clear fail 1235, else border line fail 1230.

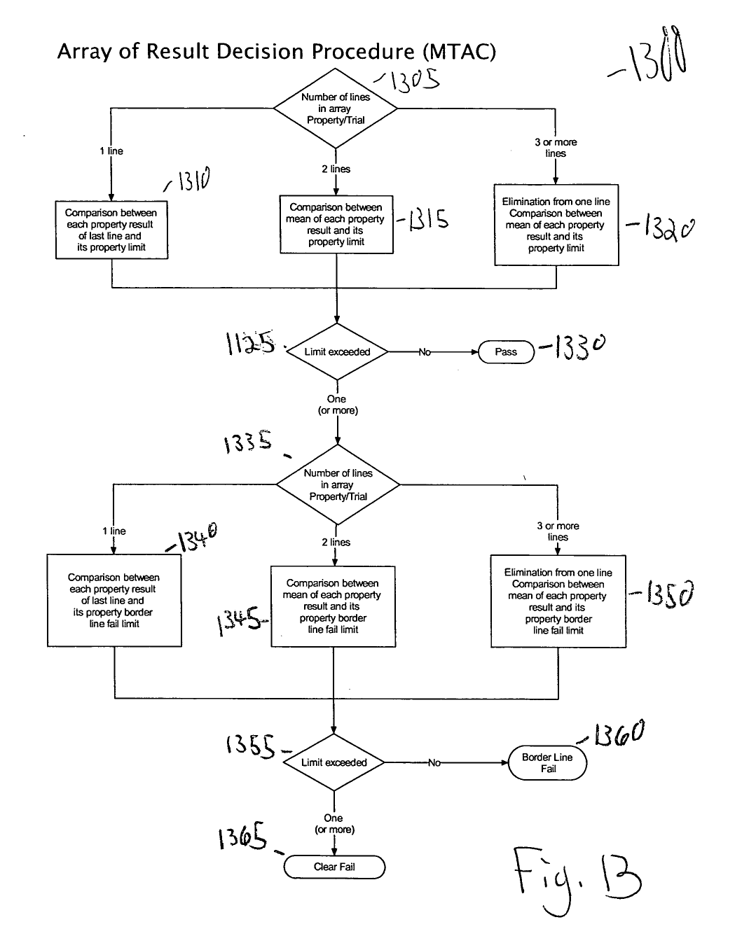

FIG. 13 depicts process logic flow for Array of Result Decision Procedure (with MTAC). Begin by determining number of lines in array property/trial 1305. If one line then make comparison between each property result of last line and its property limit 1310. If two lines then make comparison between mean of each property result of last line and its property limit 1315. If more than two lines then elimination from one line and make comparison between mean of each property result of last line and its property limit 1320. In the MTAC context, if more than 2 runs of the same oil are executed in the same engine test, results must be averaged using the appropriate MTAC rules applying to a given situation. In the case above, the 2 best results are considered only for averaging. E.g., the PQ engineer decides to repeat a VG four times on the same oil. The final result for this test will only be based on 2 of those 4 runs and possibly those 2 leading to an MTAC averaged pass. This only applies in the US for programs carried under the ACC and API codes of practice.

After any of above comparison steps, then determine if limit exceeded 1325. If not then pass 1330. if exceeded, then count number of lines in array property trial 1335.

If one line then make comparison between each property result of last line and its property border line fail limit 1340. If two lines then make comparison between mean of each property result of last line and its property border line fail limit 1345. If more than two lines then elimination from one line and make comparison between mean of each property result of last line and its property border line fail limit 1350. After any of above comparison steps, then determine if limit exceeded 1325. If not then pass 1330. if exceeded, then count number of lines in array property trial 1335.

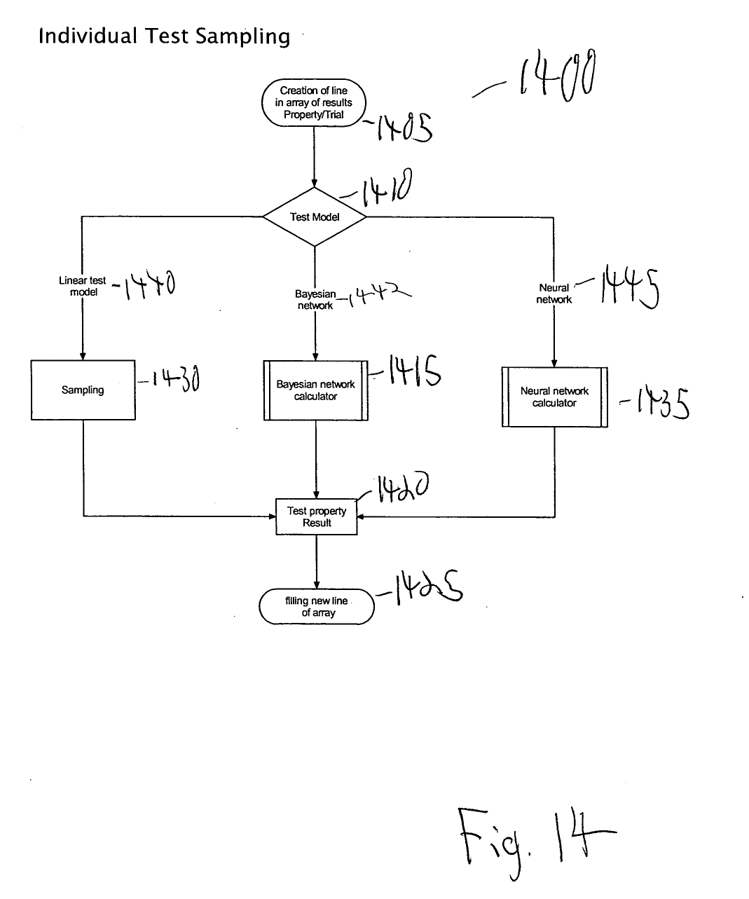

FIG. 14 depicts process logic flow for Individual Test Sampling. Begin by creation of line array of results property/trial 1405, then test model 1410. If using linear test model 1440, then do sampling 1430. If using Bayesian network 1442, then do Bayesian network calculator 1415. If using Neural network 1445, then use neural network calculator 1435. After any of above steps, then test property result 1420, then filling new line of array 1425.

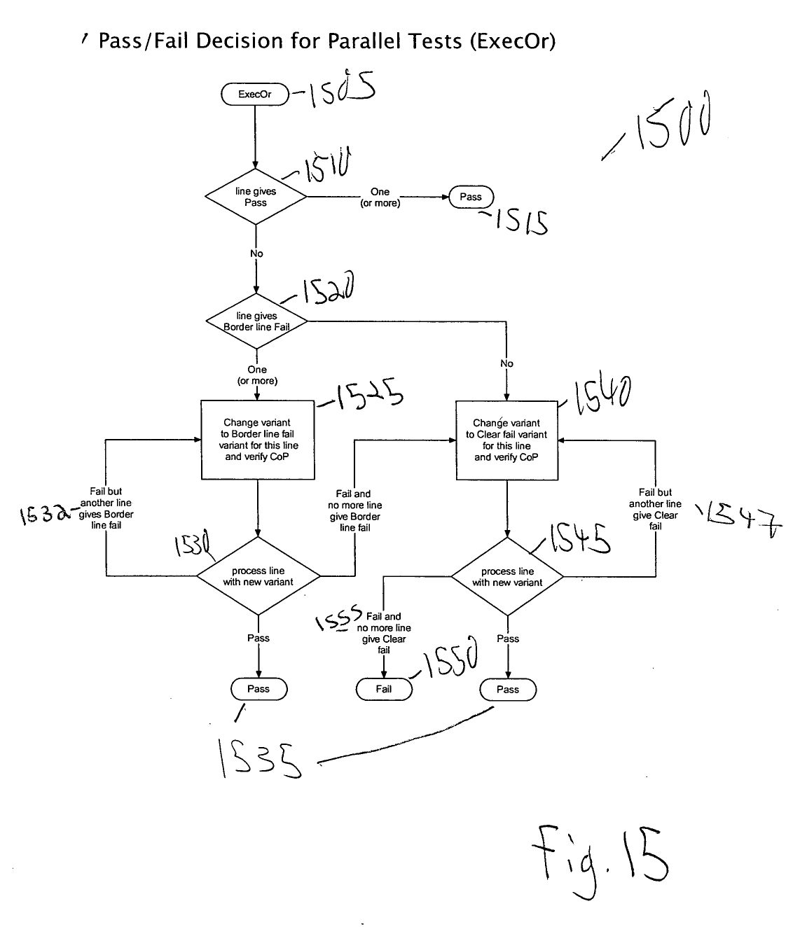

FIG. 15 depicts process logic flow for pass/fail decision for Parallel Tests (ExecOr). As an overview, this process flow diagram relates to 2 or more tests run in parallel. The program simulation moves to the next step as soon as one of the 2 tests is a pass: e.g., one can run the same test A at 2 different labs roughly at the same time. As soon as it is known one of them passed the other one is terminated and the program moves to the next step. Now the process flow is described with reference to the FIG. 15. Begin ExecOr 1505, then if line gives pass 1510 of one or more then pass 1515, if not then test if line gives border line fail 1520. If not then change variant to clear fail variant for this line and verify CoP 1540, then process line with new variant 1545.

If passes, then pass 1535. If fail, then either repeat change variant step 1540 if fails but another line gives clear fail 1547, or fail 1550 if fails and no more line gives clear fail 1555. If one or more line gives border line fail 1520, then change variant to border line fail variant for this line and verify CoP 1525, then process line with new variant 1530. If passes, then pass 1535. if fails but another line gives border line fail 1532, then repeat change variant step 1525.

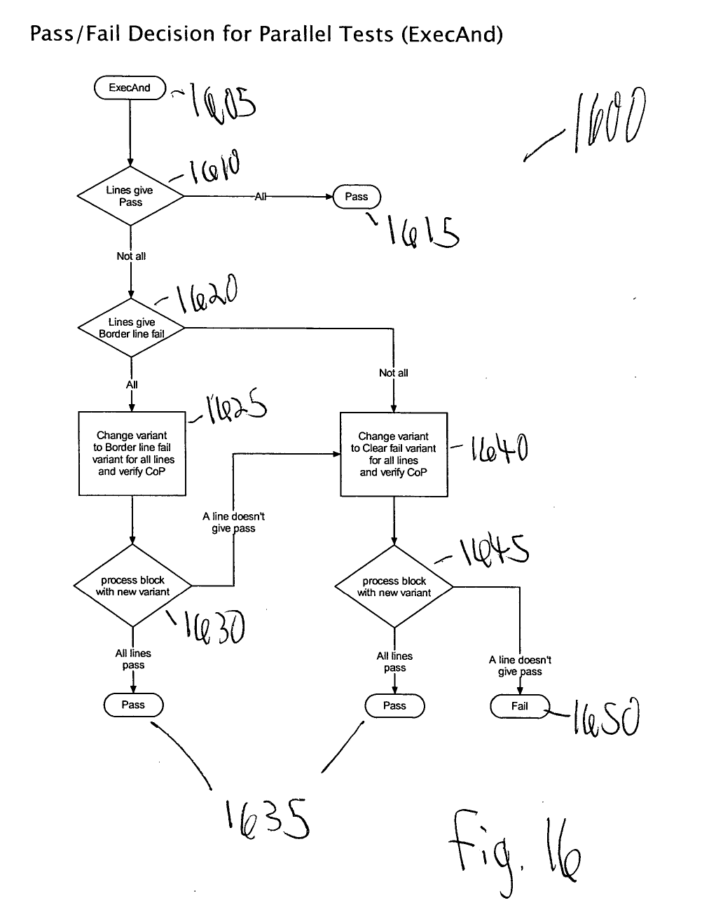

FIG. 16 depicts process logic flow for pass/fail decision for Parallel Tests (ExecAnd). As an overview, like the “ExecOr” process flow, this process flow diagram relates to 2 or more tests run in parallel. The difference with ExecOr is that in this case, all the tests being run in parallel in this step must pass before the program moves to the next phase, e.g., typically one would run tests A, B and C in parallel and the program would not move to the next step before all three tests are pass. Now the process flow is described with reference to the FIG. 16. Begin ExecAnd 1605 for, then if line gives pass 1610 for all then pass 1615, if not then test if line gives border line fail 1620. If not all then change variant to clear fail variant for all lines and verify CoP 1640, then process block with new variant 1645. If all lines pass, then pass 1635. If a line does not pass, then fail 1650. If all lines give border line fail 1620, then change variant to border line fail variant for all lines and verify CoP 1625, then process block with new variant 1630. If passes, then pass 1635. if a line does not give pass then go to change variant step 1640.

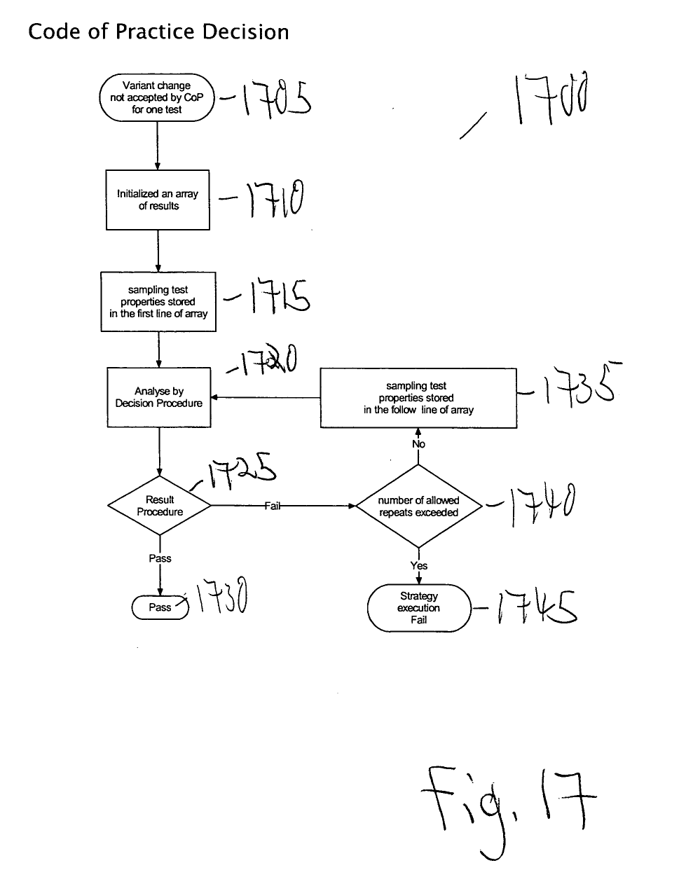

FIG. 17 depicts process logic flow for Code of Practice Decisions. Begin with Variant change not accepted by CoP for one test 1705, then initialized an array of results 1710, then sampling test properties stored in the first line of array 1715, then analyze by decision procedure 1720, an check result procedure 1725. If passes, then pass 1730. If fails, then check if number of allowed repeats is exceeded 1740. If yes, then strategy execution fail 1745. If no then sampling test properties stored in the follow line of array, and then repeat from analyse by decision procedure step 1720.

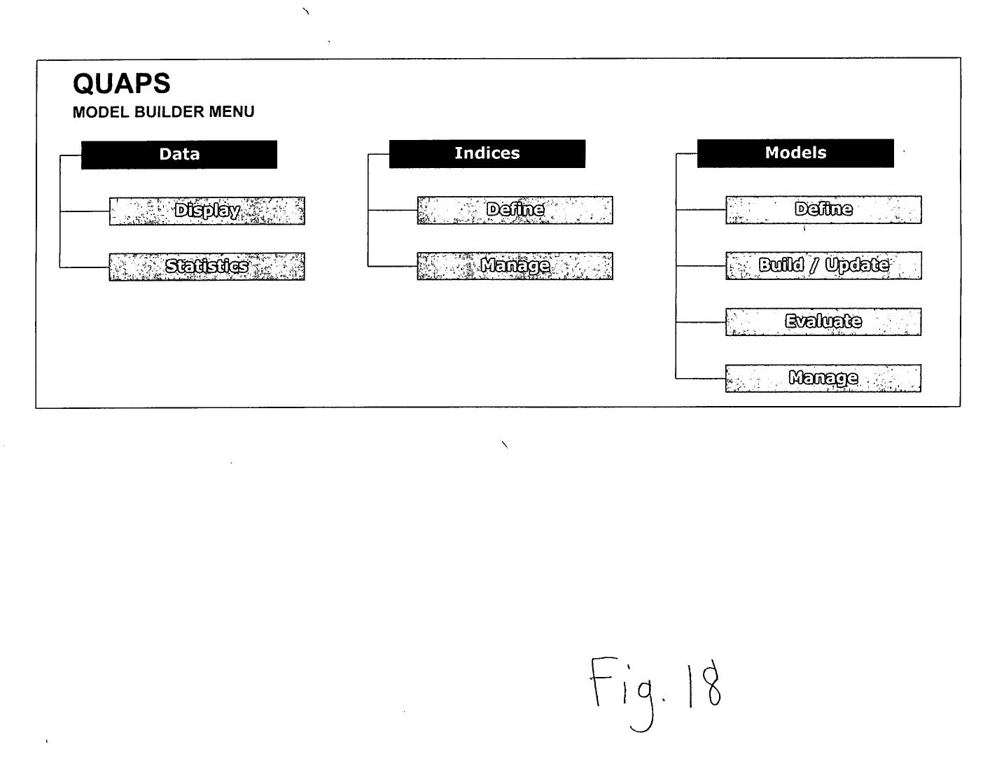

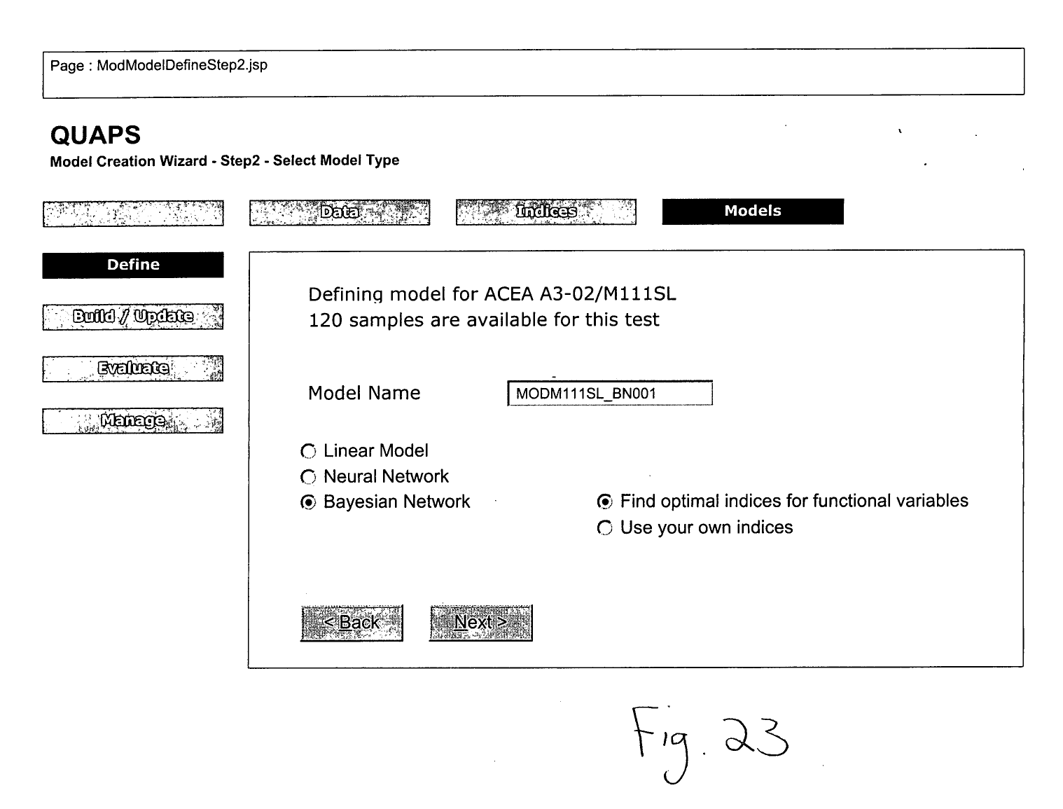

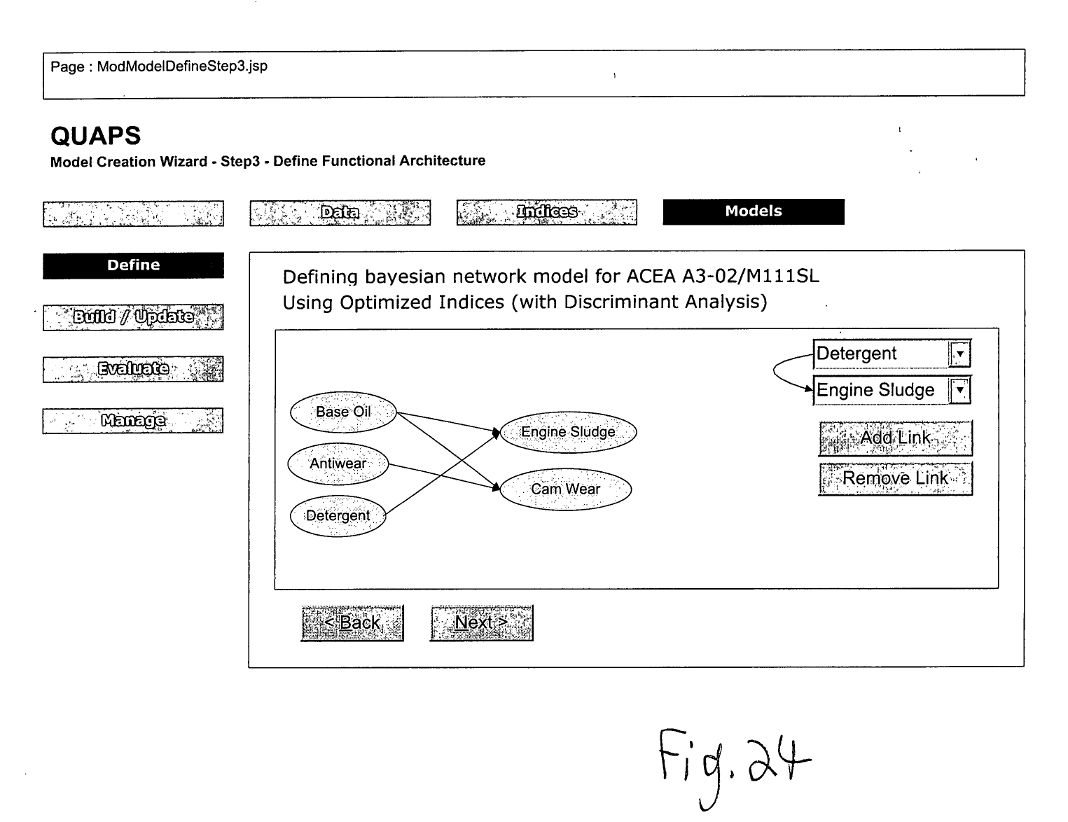

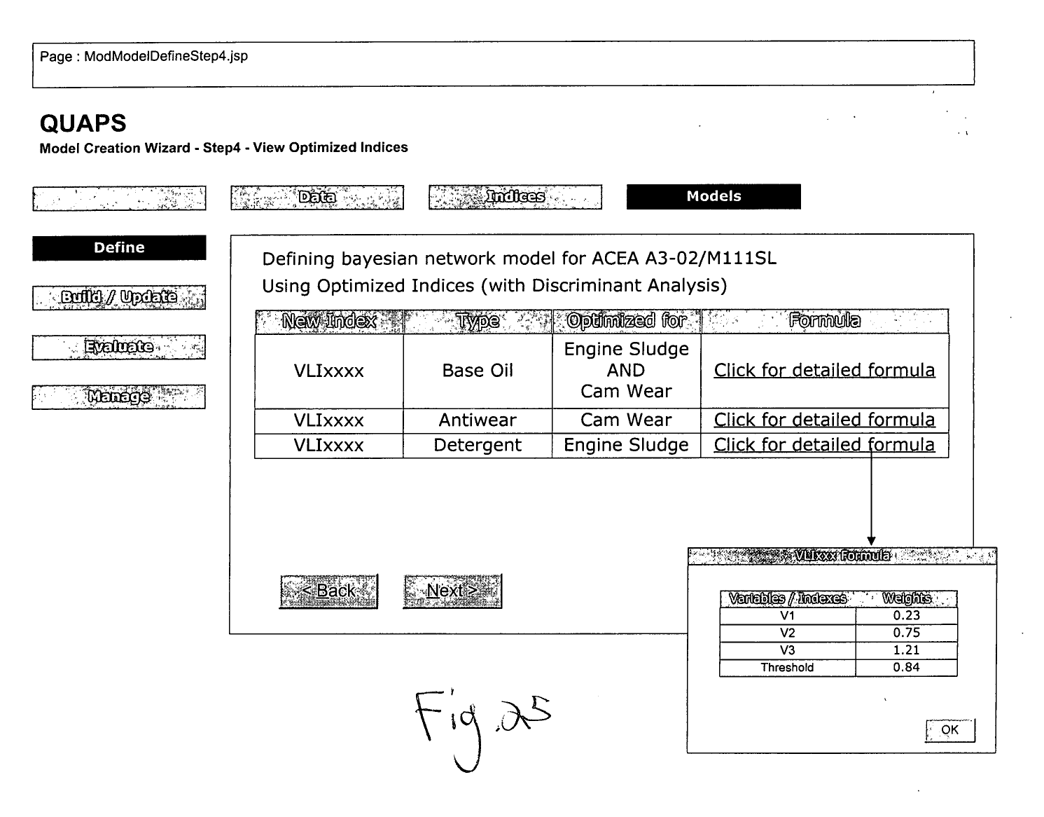

FIGS. 18-28 depict in one embodiment a graphical user interface for some aspects of the system of the invention.

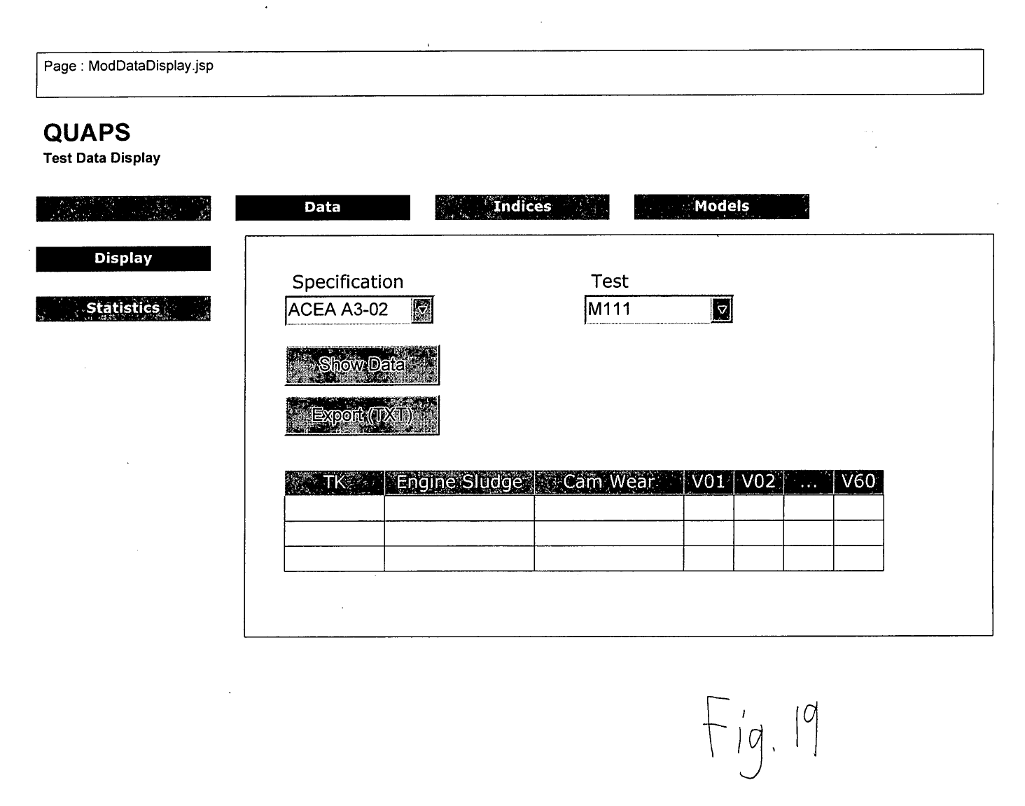

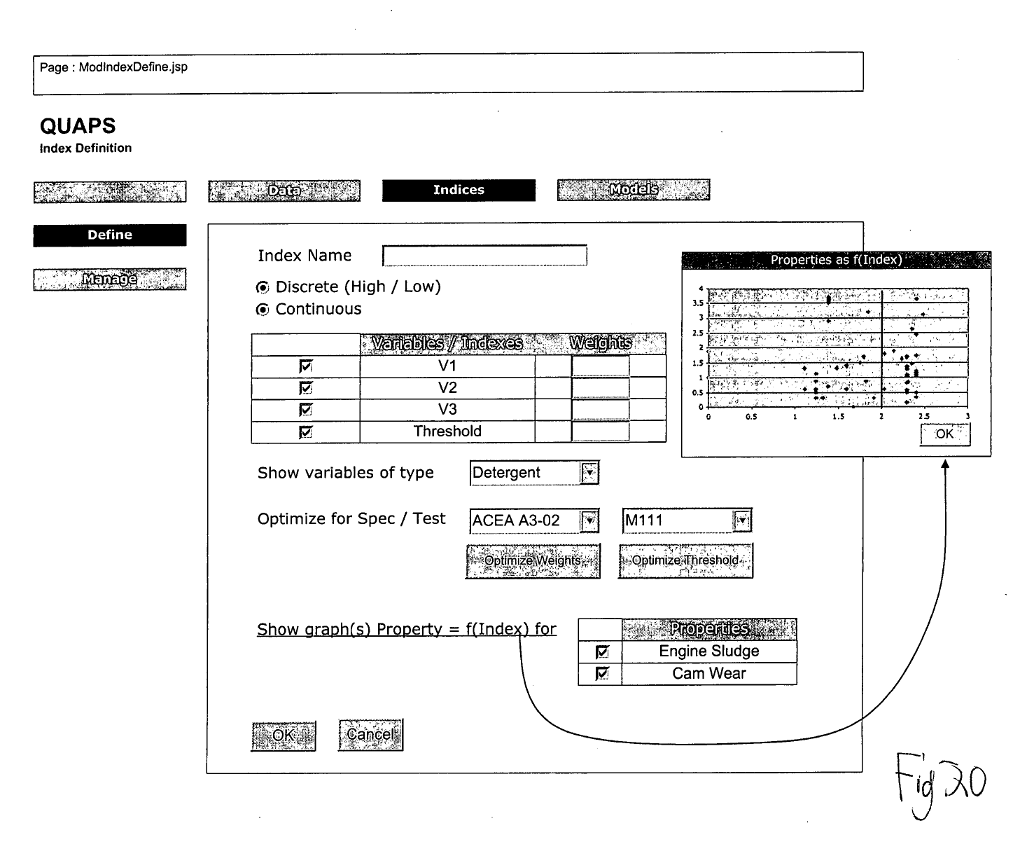

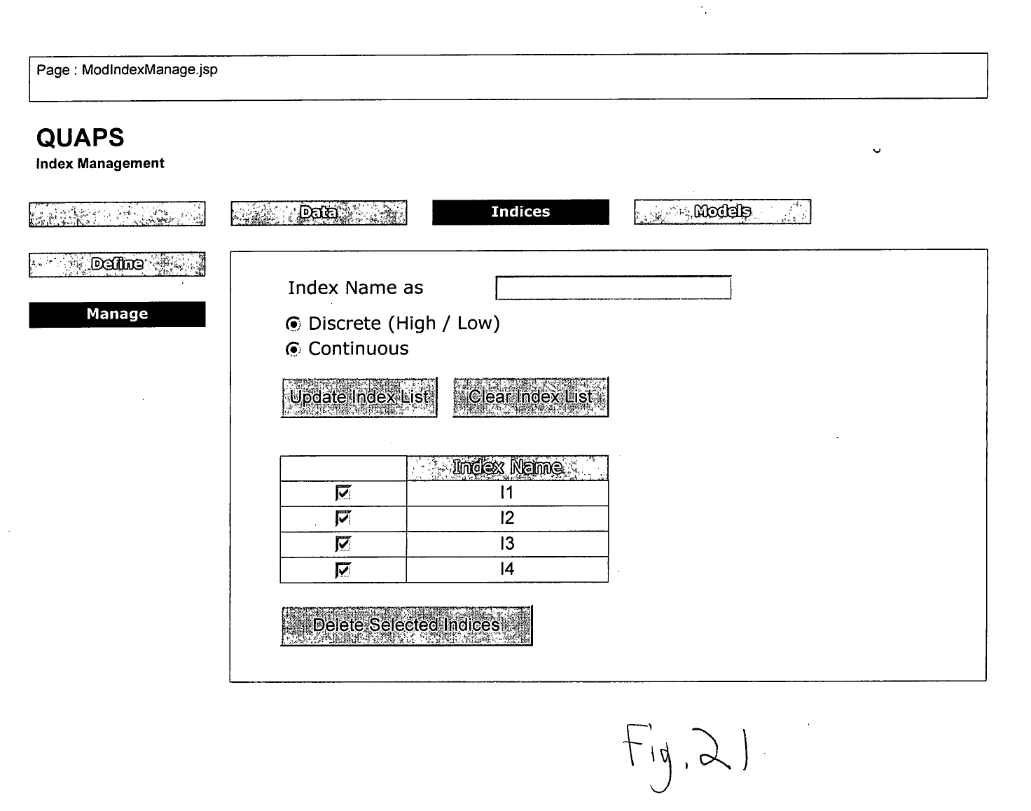

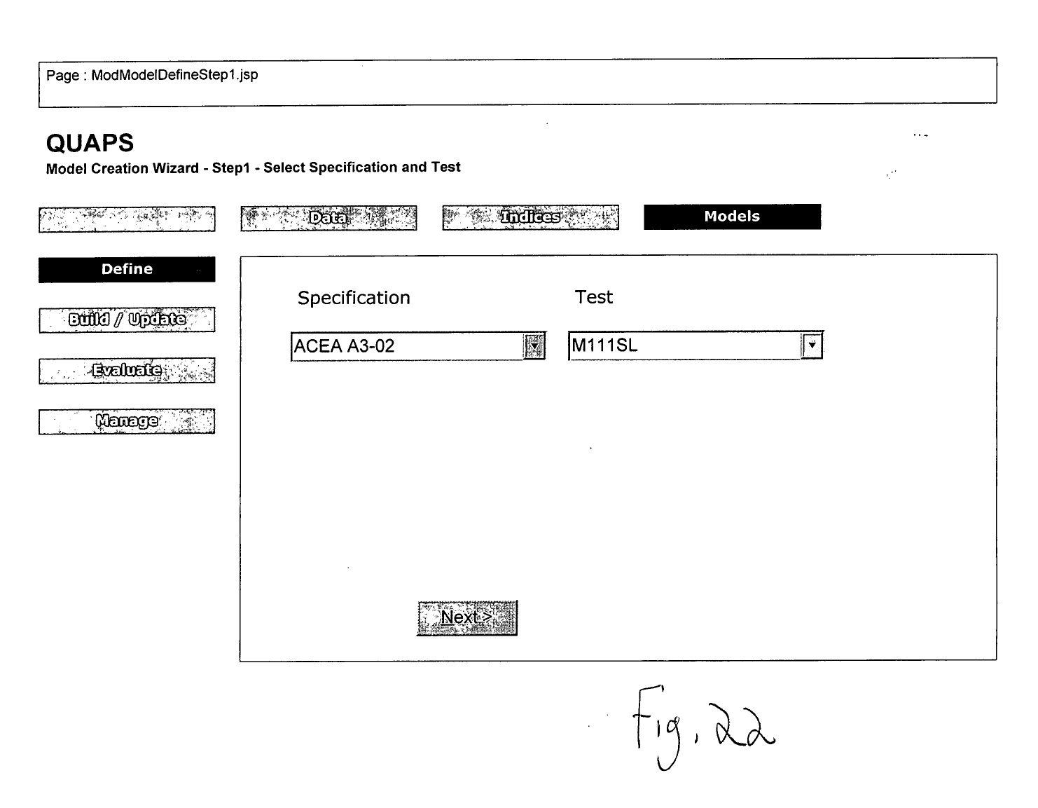

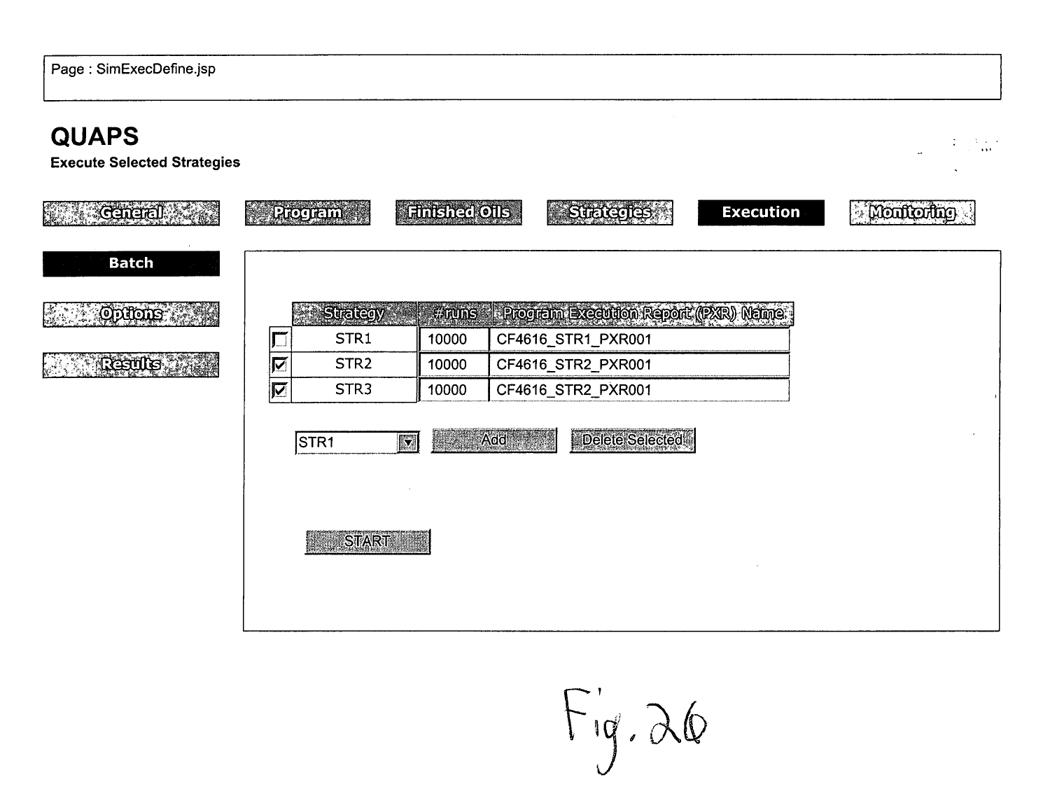

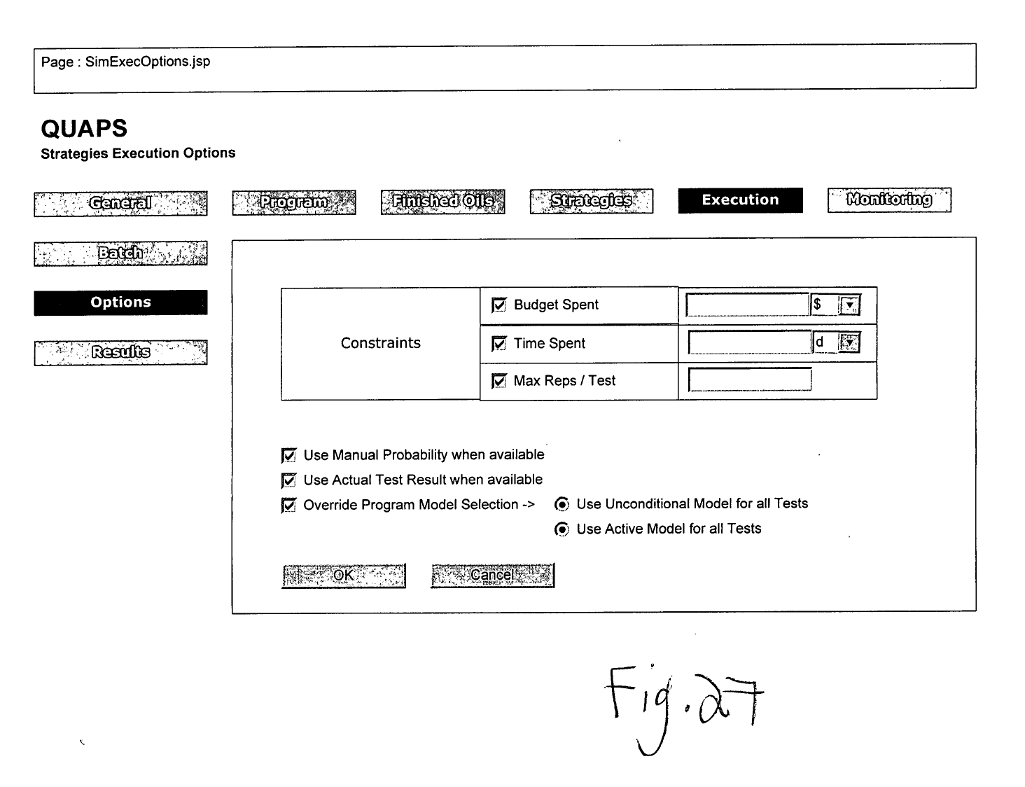

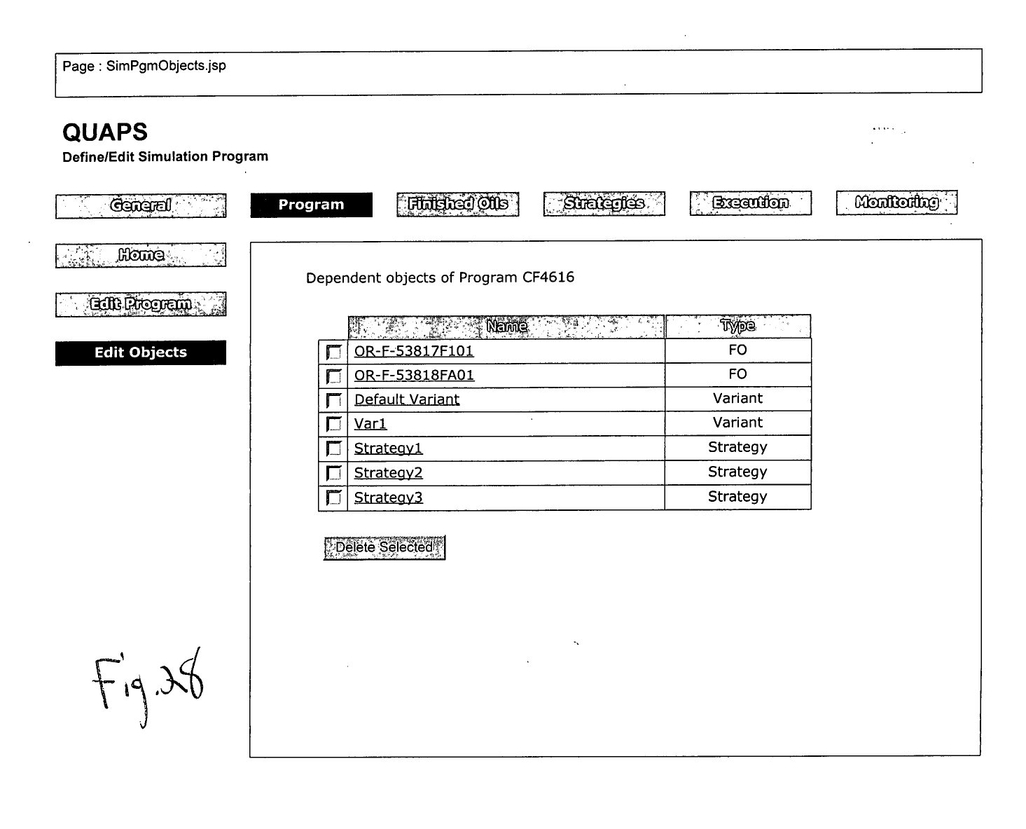

FIG. 18 depicts an illustrative high level menu for the model building aspect of the invention. FIG. 19 depicts an illustrative data display. FIG. 20 depicts an illustrative use interface regarding indices. FIG. 21 depicts another illustrative view of the indices user interface. FIGS. 22-25 depict an illustrative user interface views for selecting specifications and tests for defining models. FIGS. 26-27 depict illustrative user interface views for execution. FIG. 28 depicts an illustrative user interface view for program, edit objects.

M. Other Implementation Details

1. Terms

The detailed description contained herein is represented partly in terms of processes and symbolic representations of operations by a conventional computer and/or wired or wireless network. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

2. Hardware

It should be understood that the programs, processes, methods, etc. described herein are not related or limited to any particular computer or apparatus, nor are they related or limited to any particular communication architecture, other than as described. Rather, various types of general purpose machines, sensors, transmitters, receivers, transceivers, and network physical layers may be used with any program modules and any other aspects of the invention constructed in accordance with the teachings described herein. Similarly, it may prove advantageous to construct a specialized apparatus to perform the method steps described herein by way of dedicated computer systems in specific network architecture with hard-wired logic or programs stored in nonvolatile memory, such as read-only memory.

3. Program

In the preferred embodiment where any steps of the present invention are embodied in machine-executable instructions, the instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

4. Product

The present invention is composed of hardware and computer program products which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions.

Moreover, the software portion of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

5. Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

6. Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

7. Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

1. A method of simulating and optimizing qualification testing of lubricating oil products, the method comprising:
a. passing a plurality of lubricating oil product characteristics to a simulator engine, wherein the simulator engine comprises a plurality of simulated qualification tests and processing the lubricating oil product characteristics in one or more of the simulated qualification tests, wherein the output of each simulated qualification test includes a probability of passing indicator for indicating the probability that a lubricating oil product have the inputted characteristics would pass an actual qualification test;
b. passing an input of the plurality of lubricating oil product characteristics, the probability of passing indicator from each simulated qualification test, and a proposed test sequence of a plurality of qualification tests to a strategy simulator engine and processing the input to determine a probability of passing indicator, cost and time duration of the proposed test sequence.

2. The method of claim 1, further comprising passing as a second input the plurality of lubricating oil product characteristics, the proposed test sequence and the probability of passing indicator from each simulated qualification test to an strategy optimizer engine and processing the second input to determine an optimum test sequence, based on pre-determined criteria, for performing actual qualification tests.

3. The method of claim 2, wherein the strategy optimizer engine utilizes optimizing techniques selected from genetic algorithms, simulated annealing, and mixtures thereof.

4. The method of claim 2, wherein the pre-determined criteria comprise test sequence cost and test sequence time duration.

5. The method of claim 2, wherein the simulator engine is configured to account for a random factor for each simulated qualification test.

6. The method of claim 1, wherein the simulated qualification tests are modeled using as a third input data from actual qualification tests with modeling techniques selected from neural networks, Bayesian network, and mixtures thereof.

7. The method of claim 6, wherein the third input further comprises data from expert knowledge and wherein the modeling technique is the Bayesian network modeling technique.

8. The method of claim 1, wherein the lubricating oil product characteristics comprise base oil percentage and characteristics, viscosity index improver percentage and characteristics, additives percentage and characteristics, and pour point depressants percentage and characteristics.

9. The method of claim 1, wherein the strategy simulator engine utilizes Monte Carlo statistical techniques.

10. The method of claim 9, wherein the strategy simulator engine is configured to operate in series or in parallel on the individual simulated qualification tests of the test sequence.

11. The method of claim 1, wherein the strategy simulator engine is configured to change the characteristics of the lubricating oil product under test in a manner consistent with a pre-determined Codes of Practice for lubricant oil testing where the initial characteristics would not result in the lubricating oil product passing all qualification tests.

12. The method of claim 10, wherein the pre-determined Codes of Practice comprise permissible mid-test sequence changes of the characteristics of the lubricating oil product under test and permissible multi-grade tests.

13. The method of claim 9, wherein the strategy simulator engine is configured to produce an output for a plurality of variations of lubricating oil product characteristics.

14. The method of claim 8, wherein Codes of Practice are entered into the strategy simulator engine via a Rules Engine.

15. The method of claim 9, wherein the Rules Engine is configured and adapted to accept Rules of Practice input via a plain-English interface, and wherein the Rules Engine processes the input into a computer programming language format which provides instructions which the strategy simulator engine can read and follow.

16. A system for simulating and optimizing qualification testing of lubricating oil products, the system comprising:
a. a CPU;
b. a memory operatively connected to the CPU, the memory containing a program adapted to be executed by the CPU and the CPU and memory cooperatively adapted for simulating qualification testing of lubricating oil products;
c. a simulator engine code segment embodied on a computer-readable medium configured and adapted for receiving as input a plurality of lubricating oil product characteristics, wherein the simulator engine comprises a plurality of simulated qualification test code segments, and configured and adapted for processing the input of lubricating oil product characteristics in one or more of the simulated qualification test code segments, wherein the output of each simulated qualification test code segments includes a probability of passing indicator for indicating the probability that a lubricating oil product have the inputted characteristics would pass an actual qualification test;
d. a strategy simulator code segment embodied on a computer-readable medium configured and adapted for receiving as a second input the plurality of lubricating oil product characteristics, the probability of passing indicator from each simulated qualification test code segment, the plurality of lubricating oil product characteristics, and a proposed test sequence of a plurality of qualification tests, and processing the second input to determine a probability of passing indicator, cost and time duration of the proposed test sequence.

17. The system of claim 16, further comprising a strategy optimizer engine code segment embodied on a computer-readable medium configured and adapted for receiving as a third input an initial test sequence, the plurality of lubricating oil product characteristics, and the probability of passing indicator from each simulated qualification test, and processing the third input to determine an optimum test sequence, based on pre-determined criteria, for performing actual qualification tests.

18. The system of claim 17, wherein the strategy optimizer engine code segment utilizes optimizing techniques selected from genetic algorithms, simulated annealing, and mixtures thereof.

19. The system of claim 17, wherein the pre-determined criteria comprise test sequence cost and test sequence time duration.

20. The system of claim 17, wherein the strategy optimizer engine code segment is configured and adapted to account for a random factor for each simulated qualification test.

21. The system of claim 16, wherein the simulated qualification test code segments are constructed from a fourth input of data from a database of actual qualification tests with modeling techniques selected from neural networks, Bayesian network, and mixtures thereof.

22. The system of claim 21, wherein the fourth input further comprises data from a database of expert knowledge and wherein the modeling technique is the Bayesian network modeling technique.

23. The system of claim 16, wherein the input of lubricating oil product characteristics comprises base oil percentage and characteristics, viscosity index improver percentage and characteristics, additives percentage and characteristics, and pour point depressants percentage and characteristics.

24. The system of claim 16, wherein the strategy simulator engine code segment is constructed from Monte Carlo statistical techniques.

25. The system of claim 24, wherein the strategy simulator engine code segment is configured and adapted to process in series or in parallel the input of individual simulated qualification tests of the test sequence.

26. The system of claim 16, wherein the strategy simulator engine code segment is configured and adapted to change the characteristics of the lubricating oil product under test in a manner consistent with a pre-determined Codes of Practice for lubricant oil testing where the initial characteristics would not result in the lubricating oil product passing all qualification tests.

27. The system of claim 26, wherein the pre-determined Codes of Practice comprise permissible mid-test sequence changes of the characteristics of the lubricating oil product under test and permissible multi-grade tests.

28. The system of claim 26, wherein the strategy simulator engine code segment is configured and adapted to produce an output of a plurality of variations of lubricating oil product characteristics.

29. The system of claim 26, further comprising a Rules Engine code segment for incorporating the Codes of Practice into the strategy simulator engine.

30. The system of claim 26, wherein the Rules Engine code segment is configured and adapted to accept Codes of Practice input via a plain-English interface, and wherein the Rules Engine code segment translates the input into a computer programming language code segment configured and adapted provides instructions which the strategy simulator engine segment can read and follow.
